(19) United States
(12) Patent Application Publication
(10) Pub. No.: US 2008/0243397 A1
(43) Pub. Date: Oct. 2, 2008

(54) SOFTWARE FOR DESIGN AND VERIFICATION OF SYNTHETIC GENETIC CONSTRUCTS

(76) Inventors: Jean Peccoud, Christiansburg, VA (US); Yizhi Cai, Blacksburg, VA (US)

Correspondence Address: LATIMER, MAYBERRY & MATTHEWS IP LAW, LLP, 13873 PARK CENTER ROAD, SUITE 106, HERNDON, VA, 20171, US

(21) Appl. No.: 12/058,712

(22) Filed: Mar. 30, 2008

Related U.S. Application Data
(60) Provisional application No. 60/908,995, filed on Mar. 30, 2007.

(51) Int. Cl. G06F 19/00; G06F 17/50; G06F 17/30; G06Q 30/00

(52) U.S. Cl. 702/20; 703/11; 707/104.1; 705/35; 707/E17.019

(57) ABSTRACT

The present invention provides methods for designing and verifying nucleic acid molecules having one or more desired properties. The methods are typically encoded into software, and typically include use of databases and algorithms to determine if nucleic acid molecules designed to have various elements in functional relationships have the intended properties. The result is achieved by determining if the various elements of the designed nucleic acid are in the correct order and physical relationship to other elements, and that the proper elements are selected. Computer systems for implementing the method, as well as business methods for reaping monetary gain from use of the methods, are also disclosed.

### CROSS-REFERENCE TO RELATED APPLICATIONS

This application relies on the disclosure of, and claims the benefit of the filing date of, U.S. provisional patent application No. 60/908,995, filed 30 Mar. 2007, the entire disclosure of which is hereby incorporated herein by reference.

### BACKGROUND OF THE INVENTION

1. Field of the Invention

The present invention relates to the field of bioinformatics. More specifically, the present invention relates to computer tools for design and verification of complex or lengthy nucleotide sequences for use in expression of proteins and functional RNAs.

2. Description of Related Art

In the field of biotechnology, recent technical advances have made it possible to very accurately synthesize large nucleic acid molecules, on the order of tens of kilobases in length. Indeed, automation has reduced the time and effort involved in synthesizing large nucleic acid molecules to the point where it is often the most expedient method of assembling or obtaining a large nucleic acid of interest.

The process of synthesizing large nucleic acid molecules involves both design and verification of the sequence. Until recently, design and verification of nucleic acid sequences was performed manually, requiring much time and human intervention to create a satisfactory molecule for a given purpose. Currently, various software applications exist for design of nucleic acid molecules, such as, for example, the program Gene Designer. These types of programs allow users to design large molecules by providing the user the ability to select different elements and combine the elements in a desired order to create a final, typically long, nucleotide sequence. However, these programs do not currently guide the user in the process of designing new molecules nor do they provide the user the ability to verify that a DNA sequence contains all of the elements needed for expression of a protein, contains elements that are suitable in combination for use in the desired host, or is otherwise fully functional as desired.

Those of skill in the art recognize that, prior to synthesis of a large nucleic acid molecule, it is advantageous to ensure that the sequence to be synthesized will, in fact, result in a molecule that is suitable for its intended purpose. Typically, that purpose is to express one or more proteins of interest in a host cell of interest. Thus, for example, the sequence should be designed to contain transcription control sequences that are appropriate for the host cell, translation control sequences that are appropriate for the host cell, codon preferences that are appropriate for the host cell, and the like. Furthermore, once designed, the sequence should be verified to confirm that all elements are in the proper order, that all elements are the proper distance away from other elements, and that all of the sequences for all of the elements are correct. Unfortunately, such a verification system is not currently available in the art. Where a nucleic acid construct is complex or under complex control, verification becomes a matter of manual trial-and-error experimentation.

### SUMMARY OF THE INVENTION

The present invention addresses needs in the art by providing software that not only assists users in designing nucleic acid molecules, but also verifies the design of nucleic acid molecules. Included within the context of the invention is verification of nucleic acids that are specified by a method or software other than the one described in this invention. The software of the invention can be a stand-alone product or can be integrated into pre-existing software to provide added functionality.

Broadly speaking, the invention comprises software that can capture user-defined design principles of complex genetic constructs. Stated another way, it provides a formalized, computer-implemented approach to capture the expertise of molecular biologists and create functional nucleic acids for pre-defined purposes. The software of the invention can include one or more functionalities, such as a “software wizard”, that can guide molecular biologists or other users through the design process, ensuring that the design of a given nucleic acid is consistent with the design principles the user selected when starting the design process. The software of the invention can be provided in many forms for ease and versatility of use. For example, the wizard can be embedded in existing stand-alone software or can be provided on a web site, such as one connected to a library of genetic parts that can be selected for use in constructing and verifying a nucleic acid. Alternatively or in addition to the wizard-like functionalities, the software of the invention provides the ability to verify the consistency of constructs, particularly those that are user-defined, using a set of design rules. The design rules can be expressed as a grammar for nucleic acid sequence construction, and can be used to create a functional end-product without the need for repetitive trial-and-error experimentation at the bench. While not so limited, this function can be used by a researcher or by a commercial entity to automatically review gene synthesis requests, such as those submitted to a web site.

Persons and companies who can benefit from this invention are varied, but are typically molecular biology researchers, including those at both universities or non-profit research organizations and in industry. One particular group for which this invention is well suited is companies that provide gene synthesis services. These companies can use the invention in multiple forms. For example, the invention can help them organize their libraries of genetic parts. Further, the wizard function (discussed in detail below) can be embedded in a larger software product, enabling users who are not familiar with the function of the different elements of gene expression cassettes to build larger customized constructs than would be possible without the wizard function. The parsing function (discussed in detail below) could be used to verify large collections of previously defined genetic constructs, like the MIT Registry of Standard Biological Parts. It could also be used in conjunction with a web site of a gene synthesis company to take orders, to provide an interface for design, and to deliver a final product. For example, the parsing function can automatically flag any design inconsistency for review by the customer or a company employee.

Thus, in a first aspect, the invention provides a method for designing nucleic acid sequences having one or more desired properties. In general, the method is a computer-implemented method that comprises: providing a user the ability to select at least two elements defined by nucleotide sequences; and providing the user the ability to place each element at a correct or valid position relative to the other element(s), where the method results in a nucleic acid construct having one or more desired physical properties. Preferably, the method provides a nucleic acid construct having one or more desired functional properties as well. According to the method, the act of providing the user the ability to select elements can be any act that allows selection. Thus, it can comprise allowing a user to choose an element that he designed or that he otherwise provides (e.g., selected from a database of elements). Alternatively, it can comprise allowing a user to select an element from a list or collection of elements that are made available to the user. The elements provided to the user can be labeled with relevant information, such as function, source organism, length, ancillary elements that are required or preferred, and the like. According to the method, the act of providing the ability to place elements can be any act that allows a user to place an element at a correct/valid position within the context of the overall nucleic acid molecule. In preferred embodiments, the method is an automated method that does not require much, if any, action by the user. For example, in a preferred embodiment, the act of providing comprises displaying a list of suitable elements, and providing a user the ability to select an element by a mouse click or similar computer-implemented selection process. In embodiments, the invention provides for use of a computer program to achieve this automated process.

In embodiments, the method further comprises providing the ability to verify the correctness of the nucleic acid construct. The act of providing the ability to verify comprises computer analysis of the nucleic acid construct to determine that at least two, and preferably all, of the selected elements can act together to create a product with a desired characteristic, such as a desired function. For example, verifying a nucleic acid construct comprising a promoter and a coding region can comprise analyzing the promoter and the coding sequence to determine if they are properly spaced and can be acted upon by host cell expression machinery. The act of verifying can be any act that results in the ability to conclude with certainty that the construct is exclusively composed of previously catalogued functional elements organized according to rules deemed suitable to develop DNA molecules for a particular function by molecular biology experts. In embodiments, the invention provides for use of a computer program to achieve this automated process. Currently, there are no other algorithms known in the art that provide such a verification function.

Preferably, the act does not include actual physical testing of the construct for activity; however, in embodiments, actual physical confirmation of function is envisioned. For example, in some embodiments, the level of expression of a desired protein in a given host cell may be confirmed by in vivo or in vitro (e.g., in cell free extracts) expression of the construct. Those of skill in the art are well aware of the various assays for determining expression of a protein from an expression system, and any such assay may be used, as deemed appropriate by the user. For example, assays for the presence of a protein in an acrylamide gel (e.g., by detection of a protein band with dye or with a specific reagent, such as an antibody), can be used. Likewise, for example, detection of a given protein may be accomplished through column chromatography, interaction with a known ligand or other binding partner (e.g., enzyme-substrate reactions), or sequence determination can be used. Other non-limiting examples will be immediately apparent to those of skill in the art. It is to be understood that the knowledge of the biological function of the expressed protein is not necessary for those of skill in the art to be able to identify the expressed protein. For example, a protein of a given molecular weight may be calculated from the nucleotide sequence of the coding region, and the appearance of a protein band on an acrylamide gel (as compared to a negative control expression reaction) of the appropriate size is indicative of expression of the protein of interest.

It is to be noted that, for convenience and brevity, the present disclosure discusses design and verification in terms of expression of protein products. However, the discussion herein is to be understood as encompassing design and verification of nucleic acid constructs having any, and any number of, desired characteristics. That is, although one typical use for the present invention will be in the design and verification of nucleic acids for expression of proteins, design and verification of nucleic acids that do not express a protein are also encompassed by the invention. Thus, for example, creation of a nucleic acid for use as a probe for the presence of transcription factors or complexes of transcription factors and other transcription control molecules is contemplated, as well as construction of expression vectors (lacking any particular protein coding regions). Likewise, the method can be used to design and/or verify a nucleic acid sequence to act as a promoter or other intrinsic functional element (e.g., design of a valid synthetic promoter). Additionally, the method may be used as a method of designing/validating a fusion protein or chimeric proteins by combining two or more functional domains, such as a protein comprising a fluorescent or purification tag, or a chimeric transcription factor comprising domains derived from two or more different proteins. The methods of the invention are powerful and useful for a variety of nucleic acid construction purposes, and the use of protein expression as an example is not to be considered a limitation on the scope of the invention.

In the context of the invention, the act of providing the ability to verify a sequence is an automated act implemented by way of computer software. No human intervention is required (other than possible input of data, such as by selection of nucleic acid elements). The act of verifying is discussed in more detail below.

In another aspect, the invention provides a method for verifying the adequacy of a nucleic acid construct. As with the method for designing nucleic acid constructs, the nucleic acid construct according to this method may be any nucleic acid, but is typically one comprising two or more functional elements. For example, it can be a multi-element molecule designed by a researcher for expression of a protein in a host organism. In some embodiments, it is a multi-element nucleic acid molecule designed using the method described above. In general, the method for verifying nucleic acid constructs is a computer-implemented method that comprises: obtaining a nucleic acid sequence of interest; analyzing the sequence to identify in the sequence functional elements listed in a library of genetic parts; and determining if two or more of the functional elements are in the correct physical relationship to each other to provide the desired function for one, two, or more of the elements. In some embodiments, the method further comprises determining if two or more of the functional elements are compatible with each other and the host cell expression machinery such that, when introduced into a host cell, a functional expression product can be produced. For example, the method can include obtaining a nucleic acid sequence from a user, where the sequence comprises a transcriptional promoter, a ribosome binding site, a protein coding sequence, and a transcriptional terminator. The method can further comprise analyzing the sequence to identify each of these elements. It then can comprise determining what type of element each one is (e.g., promoter, coding sequence, etc.) and comparing the elements to a general scheme for element placement to determine if the elements are all placed in the correct order. Preferably, all of the elements present on a construct are analyzed for proper spacing and physical relationship to each other. In embodiments, the invention provides for use of a computer program to achieve the automated process.

The act of obtaining a nucleic acid sequence of interest can be any act that provides a nucleic acid sequence in a form suitable for computer analysis. Thus, for example, a user can provide a computer-readable nucleic acid sequence by file transfer to a computer running the computer program or accessible by the computer program. Alternatively, for example, the nucleic acid sequence can be supplied by manually typing in the sequence, or by instructing the computer program to obtain the sequence from a database. Where the sequence is obtained from a database, the database may be one that is publicly available or one that is proprietary to the operator of the method. In summary, the act of obtaining can be an active action performed by the computer program or a passive action through which the computer program is supplied with the nucleic acid sequence.

The act of analyzing the nucleic acid sequence comprises determining the functional and non-functional elements present within the sequence and determining their physical relationship to each other. Determining functional and non-functional elements can be accomplished by any suitable means, but will typically be through the use of tags or labels associated with each element or through comparison of sequences to known sequences in one or more databases. More specifically, the nucleic acid sequence obtained in the method can be obtained as a set of sub-sequences, some or all of which being associated with a tag, such as one that indicates the function of the sub-sequence (e.g., “promoter”, “coding region”, “linker”, “ribosome binding site”, etc.). In such cases, the act of analyzing can comprise identifying the tag or label for each element and correlating it to a particular nucleic acid sequence (sub-sequence). Alternatively, sub-sequences within the entire obtained sequence can be identified through comparison of a portion or all of the sequence with known sequences in one or more databases (e.g., GenBank). Comparison of these sequences results in identification of sub-sequences with known functions and identification of sub-sequences with no known functions.

Where an element is not associated with a tag or label when obtained, the method can further comprise associating a tag or label with an element. The tag or label may then be used as an indicator of the element for other actions within the method. In addition, the tag or label may be permanently associated with the element for storage in a database for future use.

In the method for verifying the adequacy of a construct, the method comprises determining if two or more elements are in a correct physical relationship to the other(s). It is known in the art that expression of proteins from a nucleic acid requires a sequential linear arrangement of elements along the nucleic acid. There are numerous elements required for expression of proteins in various organisms, and the necessary elements for expression of a given protein in a given organism can be identified with ease, even where the precise function of each element is not completely mapped. The method of the present invention captures in a computer program these necessary elements and the rules associated with each element for its proper use within the context of expression of a protein in a given host cell. The act of determining the proper physical relationship of two or more elements applies these rules to verify that elements of interest are in the proper physical relationship to each other to allow expression of a protein. In essence, the rules form a grammar for expressing a protein. Many rules are applied by the method, non-limiting examples of which include: linear order of functional elements (e.g., 5′ to 3′ placement of elements), spacing of functional elements (e.g., number of nucleotides between ribosome binding site and coding region), functionality of element in a chosen host cell (e.g., bacterial promoter vs. eukaryotic promoter), and requirement or desirability of the presence of an element in an expression construct (e.g., mRNA terminator sequence; use of bacterial promoter in bacterial host cell).

Within the method, a decision tree or hierarchy of rules can be applied to determine if elements are disposed within the nucleic acid sequence properly. In this way, where two rules conflict or are otherwise incompatible, a suitable construct may be devised to provide an adequate result. For example, where two rules conflict with regard to spacing of elements, the rule that is assigned as having a higher importance can be selected. Alternatively, where the two rules conflict, the method can determine an intermediate spacing that, while perhaps not optimal, will allow for adequate expression of the target protein.

In embodiments, the method of verifying the adequacy of a nucleic acid construct can comprise providing a warning or other notification when two or more elements are not properly ordered or otherwise violate the grammar of the construct. Likewise, the method can comprise providing suggestions for proper ordering and/or spacing of two or more elements. Yet again, the method can comprise providing suggestions for selection of additional or alternative elements to improve design of the nucleic acid molecule. It is to be understood that the term “ordering” and its various forms encompasses not simply the physical order of the elements, but the spacing of the elements as well. Thus, where two elements are in the proper order, but an improper or disadvantageous distance apart, the method of verification can provide a suggestion for improving the design by lengthening or shortening the distance between the two elements, for example by inserting a linker or “stuffer” fragment between the two elements. In preferred embodiments, the method is an automated method that does not require much, if any, action by the user.

In embodiments, the method of verifying comprises consulting a database of nucleic acid elements. The database can comprise nucleic acid elements, and can be used not only in the context of the method of verifying, but in the method of designing as well. Within the database, nucleic acid elements are preferably associated with tags or labels that indicate general information about the element. For example, the database can contain a set of prokaryotic promoters, a set of eukaryotic transcription factor binding sites, a set of prokaryotic ribosome binding sites, a set of prokaryotic transcription terminators, etc. Each of these sets of elements thus can comprise a tag indicating its general function (e.g., “prokaryotic promoter”). Tags may contain ancillary information as well, which can be used by the method to better design or verify nucleic acid constructs. For example, the tags may specify the type of organism from which the element derives (e.g., Gram+bacterium), or even the particular species from which it derives (e.g., E. coli). Of course, other information may be included as well, and may be selected as seen fit by users implementing the method. The information provided in the tag can be used to determine suitability of one or more elements of the designed nucleic acid construct within the context of the construct as a whole and the intended use of the construct.

The database can comprise nucleic acid elements taken from public databases, proprietary databases, supplied by users, or any combination of these. According to the method, the elements are labeled with one or more pieces of information about the identity, function, and preferably source of the element. These labels are typically short codes for each element, its function, and its source. One or more of the labels for each element can be used in the grammar of the method of the invention to determine suitability of the element within the context of the entire construct. As new elements are discovered and characterized in the art, they can be added to the database to maintain and improve robustness and provide additional opportunities for arrangement of suitable elements in a nucleic acid construct.

As a general matter, the method may consult one or more databases. However, typically, a single database having information of interest for use in the present methods will be accessed. This database may be created by each user of the method or may be a centralized database that is accessible by all users of the method (e.g., a web-based database that can be accessed by users through the Internet).

The database is of exceptional value in the methods for designing nucleic acid constructs. Due to the fact that the database contains numerous nucleic acid elements as tagged entries, users wishing to create a nucleic acid construct to achieve a particular function will have all of the tools needed to do so simply by utilizing the methods of the invention. For example, a user wishing to express a protein in E. coli may access a web site providing the methods of the invention, select all of the required elements for expression, verify that the elements are in the proper order and are suitable for use in E. coli, and create the nucleic acid construct. Such a user would need no prior knowledge of E. coli elements or their proper linear arrangement, but would rather merely need to follow the method of the invention, as implemented on the web site. Furthermore, where the initially selected elements do not satisfy the required grammar for the construct, alternative elements present in the database may be selected (typically from among one or more suggested alternatives supplied by the method of the invention) to achieve a suitable construct.

One advantageous piece of information that can be associated with each nucleic acid element within the database can be the intellectual property (IP) status of the element or its encoded product. It is well known in the art that isolated or purified genetic material and proteinaceous material may be patented in the U.S. and other countries. Molecular biologists wishing to create a nucleic acid construct for expression of a given protein may wish to do so for commercial purposes, and in doing so may violate another's IP rights. The methods of the invention, and the database(s) associated with those methods, can assist users in determining whether or not to proceed with physical construction of a desired nucleic acid (and expression of a protein from that nucleic acid) by alerting the user to the IP rights associated with one, some, or all of the elements selected for a construct. Providing the IP status of the elements allows users to take appropriate action to avoid any legal consequences of use of others' IP rights, such as by substituting one element for a functionally equivalent element (i.e., substitute an element not covered by IP rights for one that is covered by IP rights). From another perspective, providing a tag having IP status information allows IP owners to monitor and/or monetize use of their IP, for example by licensing IP rights to users of the IP.

In view of the above disclosure, it is evident that the invention provides a method of nucleic acid design and verification. In essence, the method combines the two methods discussed above. In general, the method of design and verification is an automated method that comprises: providing a user the ability to select at least two elements defined by nucleotide sequences; providing the user the ability to place each element at a desired position relative to the other element(s) to create a sequence; analyzing the sequence for functional elements present in the sequence; and determining if two or more of the functional elements are in the correct physical relationship to each other to provide the desired function for one, two, or more of the elements. In embodiments, the method further comprises providing information to the user to indicate a condition where two or more elements are not in the proper physical relationship.

As with the methods of the invention described earlier in this disclosure, the method of design and verification relies, at least in part, on application of a grammar for correctly combining two or more nucleic acid sequence elements. The grammar is based on assignment of tags or labels to each element, and associating rules for construction of nucleic acids to each element. A computer program according to the invention (discussed below) assembles the elements selected by the user, determines, using the rules associated with each element (i.e., the grammar) if the elements can be assembled in the way chosen by the user, and either creates a valid construct or indicates to the user that one or more grammar violations have occurred. In embodiments where one or more errors in user-selected elements and spacing are identified, the method can include providing alternative elements for use in the construct or alternative placements of elements within the construct, preferably in the form of suggestions of suitable choices of elements or spacings.

As mentioned above, the methods preferably are automated and reduce the amount of input and activity required from users. Accordingly, in one aspect, the invention provides computer software. In general, the software of the invention comprises instructions that can be executed on a computing device, where the instructions are for carrying out a method of the invention. As a general matter, the software of the invention will rely on computer code for implementation. Those of skill in the art are aware that a computer program that implements a method of the present invention may take numerous different forms, and may be written in numerous different ways to achieve the same goal. It is thus not relevant what form the computer code takes or what language the software is based on as long as the result is a computer program that implements a method of the invention. It is well within the level of skill of those of skill in the art to create a computer program to implement a method of the invention, and any such computer program is envisioned by the invention. Thus, the code may be object code or source code. Likewise, the computer language may be C, C++, Perl, Python, Java, Basic, etc. Those of skill in the art are aware of numerous computer languages, and any of the various languages can be used to develop the software of the invention. Likewise, the software may be designed to run on any known platform and operating system. Thus, it can be designed to be implemented on a personal computer using the Windows or Vista operating system, a personal computer using the Linux operating system, or a personal computer running the Mac operating system. It also may be implemented on a computer using a UNIX based operating system (other than Linux), a computer using a Silicon Graphics (SGI) system, or any other system.

In preferred embodiments, the software of the invention provides one or more options for user interaction. For example, the software may provide the user the ability to import sequences or elements for use in the methods of the invention. It also may allow users to order elements (whether imported by the user or selected from pre-defined elements provided by the software). In addition, it may allow users to alter elements and relationships before or after verifying the elements and their order and relationships. It is to be understood that these actions by the users are qualitatively different than actions required by methods and systems currently known in the art in that the user (e.g., human) actions according to the present invention relate to selecting of elements/sequences and providing of elements/sequences, and do not relate to physical testing of suitability of elements and combinations of elements. In other words, the present methods and computer programs do not merely allow a user to combine two or more nucleic acid elements into a single construct for synthesis, but rather additionally can verify that the final construct is suitable for its intended purpose, and, if not, allow a user to alter the elements and their placement to achieve a suitable construct.

The software of the invention can further provide the user with a final nucleotide sequence for the nucleic acid construct that is designed. The nucleotide sequence can be provided in any form, but is preferably provided as a computer file that is suitable for importation into an automated process to synthesize nucleic acid constructs. Such automated processes are well known in the art and commercially available.

The software of the invention can comprise a stand-alone application, or it can be integrated into another application or program to provide added functionality to that application or program. Thus, for example, software for executing the method of verification can be implemented as an additional feature of an application that provides for nucleic acid design. Likewise, the software for implementing the method of design, the method of verification, or both, can be integrated into an application or program for general nucleic acid analysis. In essence, the software of the invention can be used in any setting, and in conjunction with any other software. It is a matter of routine work for those of skill in the computer arts to integrate software according to the present invention into other programs or applications.

Among the many advantages of the automated aspect of embodiments of the invention include the ability to completely or substantially automate the process of design of valid nucleic acid constructs. More specifically, because the present methods include use of a database of elements and a grammar for assembling those elements into valid constructs, the method, in embodiments, may be implemented as an automated method for designing valid constructs, which comprises receiving a list, order, etc. for construction of a nucleic acid that is suitable for a particular purpose (e.g., expression of a desired protein in a desired expression system), and automatically selecting the correct elements and spacing of elements to achieve that purpose. For example, a user may submit a request to a web-based system implementing a method of the present invention for a nucleic acid construct suitable for expression of B. subtilis acetate kinase in E. coli. Using the method of the invention implemented in a computer context and a database of elements, the method can design a valid construct for that purpose. In this way, the user would need no knowledge of the actual nucleic acid elements and spacing required for production of the acetate kinase, but instead would rely on the automated method of the invention to create the correct construct. Of course, where desired, the user could supply some of the elements to be used, or could be guided in selection of elements based on a limited list of suitable elements, resulting in a semi-automated method. As another example, a user may wish to design a construct for expression of acetate kinase recombinantly in E. coli, but desire to do so without the need to worry about infringement of any IP. The user could use the automated method of the invention to select the appropriate elements for construction of the nucleic acid of interest without the need to consult any patent databases. Of course, this concept can be generalized to considerations other than IP, such as length of nucleic acid sequence, solubility of encoded protein, pH optimum of encoded protein, and the like. Where multiple constructs are possible under the given parameters specified by the user, the automated method could provide all of the possible constructs that are consistent with the grammar. The automated method could also prioritize the possibilities based on factors supplied by the user or any other factors. On the other hand, where no constructs can be designed that fit the characteristics of the user, the method can provide a list of constructs most closely matching the desired characteristics and allow the user to select one.

In yet another aspect, the invention provides a computing device comprising the software of the invention. In general, the computing device is any device that is capable of executing the instructions of the computer software of the invention. While any device that is capable of executing computer software is encompassed by the invention, typically the computing device will be one that is suitable for creating, analyzing, and displaying complex nucleic acid sequences, such as a personal computer or other computer with at least as much computing power and graphics abilities. In embodiments, the computer is a microcomputer or minicomputer, which can be capable of servicing one or more users at one time. Typically, the computer is one that has at least one central processing unit that is capable of executing the instructions provided by the software of the invention. Preferably, the computing device has, or has access to, long-term storage capabilities for maintaining a database of nucleic acid elements and associated tags and grammar rules. In embodiments, the invention provides for use of a computer to implement the methods of the invention.

The invention further provides a system for implementing one or more methods of the invention. In general, the system comprises at least one computing device and computer software that comprises enough instructions to provide at least one feature of a method of the invention. Preferably, the system comprises one or more databases of nucleic acid elements and their associated tags and grammar rules. For example, the system may comprise a personal computer with software for designing and/or verifying a nucleic acid sequence. Alternatively, the system may comprise two computing devices, one of which comprises the software of the invention and the other of which comprises a local device for accessing the first device, where the two are connected in a way that allows information to pass between them. For example, the system may comprise a first computer comprising the software, which is connected to the Internet, and a second computer that does not comprise the software, but which is also connected to the Internet. The second computer may access the first computer, provide input where needed, and optionally receive output (such as a final nucleotide sequence). In such embodiments, the first device may be a web server or other computer present on the Internet, which runs the software of the invention and allows access by users to the software. As mentioned, in some non-limiting embodiments, the system comprises one or more databases to hold relevant information, such as functional elements, correlation tables to provide functional links between elements, information about users (e.g., previous constructs designed and verified), and any other information that might be relevant to design and/or verification of nucleic acids. Such databases may be present on the computing device running the software of the invention or may be present on another device, which is accessible by the computing device running the software. Of course, where desired, a portion of the software of the invention may be present on one computing device while one or more other portions may be present on other computing devices, where all of the computing devices are linked in a way that they can function together to implement a method according to the invention. Exemplary embodiments include computing devices that are connected to the Internet. Accordingly, the system of the invention can comprise one or more web pages that provide an interface between users and the software of the invention. As should be evident, any number of pages and any type of designs can be used in accordance with the invention. In general, the system encompasses all types of computer architectures without limitation, including client-server or web service. It is a matter of routine work for those of skill in the computer arts to implement such systems. In embodiments, the invention provides for use of the system of the invention to implement the automated processes of the invention.

The software of the invention can be run on any type of computing device. Typically, the computing device will comprise one or more storage media for storing computer programs. Thus, the invention provides a storage medium for storing and retrieving the software of the invention. The storage media can be any medium that is suitable for storage of computer software. It thus may be a disk that stores information by way of magnetism (e.g., hard drive, tape), an optical disk (e.g., CD, DVD), a flash drive or stick, and the like. In some embodiments, the storage medium is removable and can be used on multiple machines (e.g., CD, flash drive).

In yet a further aspect, the invention provides a method of doing business using a computer. In general, the method comprises providing a user with software or a software-based service according to the invention, and charging the user money to use the software or service. By providing it is meant any act that allows a user access to the functionalities of the software. It thus may be by way of sale of a storage medium holding the software of the invention or by providing access to the software (and/or databases) of the system by way of a computer-to-computer link. While sale of storage media is contemplated by the invention, typically, this aspect of the invention relates to situations where the user has not purchased a storage medium comprising the software, but rather is using the software by accessing a web site that offers the services of the software for a fee. This aspect of the invention is particularly advantageous to users who need the services only occasionally, and thus cannot justify the cost of buying the software as a stand-alone purchase (e.g., on a disk), who have need of the services but do not have access to suitable databases, or who do not have the computing power or storage space to implement the invention in its entirety. There are numerous ways of charging users for use of a system, and all such ways are encompassed by the present invention. One method of charging users is by way of an access fee, which can be based on number of times the software is accessed (i.e., a per-use charge). Another method is by way of charging a fee for providing unlimited access for a period of time (e.g., a daily access fee, a weekly access fee, a monthly access fee). Yet again, fees can be charged based on the number of molecules designed or verified. There are numerous other ways of charging users of the system, and all need not be detailed herein.

One non-limiting example of implementation of the method of doing business involves use of a system of the invention by a commercial gene synthesis company. Typically, such companies receive requests from customers for synthesis of nucleic acid constructs. The nucleic acid sequences are provided to the company by the customer electronically as data files, and the data files are converted by the company to actual nucleic acids through industry-standard nucleic acid synthesis methods, such as those using robots. By implementing the systems and methods of the present invention, for a fee the gene synthesis company can allow customers to design and verify a construct on the company's web site, then submit the nucleic acid sequence for synthesis. In this way, the customer can expedite design, validation, and submission for synthesis, while the company can generate more revenue and increase customer satisfaction.

Yet another non-limiting example of implementation of a method of doing business involves providing a customized, optimized system for nucleic acid construction for a particular company. In this example, the system of the invention can be provided to a customer for a fee. The customer may be a company that typically uses one or few expression systems for expression of certain protein products. In such a situation, creation of a “standard” genetic construct having pre-defined functional elements for expression of any number of different proteins in each system can be accomplished, and the “standard” construct used as a basis for creating and validating additional constructs comprising each different protein. In essence, the system can be used to create a valid grammar for expression of any number of different proteins in a given system, thus reducing the cost and time involved in creating new constructs for each protein of interest. The “standard” construct can be used not only for optimization of expression, but for standardization of expression for all of the company's protein targets as well. In this way, variations in expression levels, host cell toxicity, etc. due to construct design can be minimized or eliminated, allowing the company to draw stronger conclusions about the target protein and troubleshoot variations in batch-to-batch expression results.

### BRIEF DESCRIPTION OF THE DRAWINGS

The accompanying drawings, which are incorporated in and constitute a part of this specification, illustrate embodiments or features of the invention, and together with the written description, serve to explain certain principles of the invention. It is to be understood that the drawings are not to be considered as limiting the scope or subject matter of the invention in any way.

FIG. 1A illustrates the general design process of a method according to the invention for applying a grammar according to the invention to create a valid nucleic acid construct.

FIG. 1B illustrates a verification process according to the present invention.

FIG. 2 provides a flow chart of a construct verification algorithm according to an embodiment of the invention.

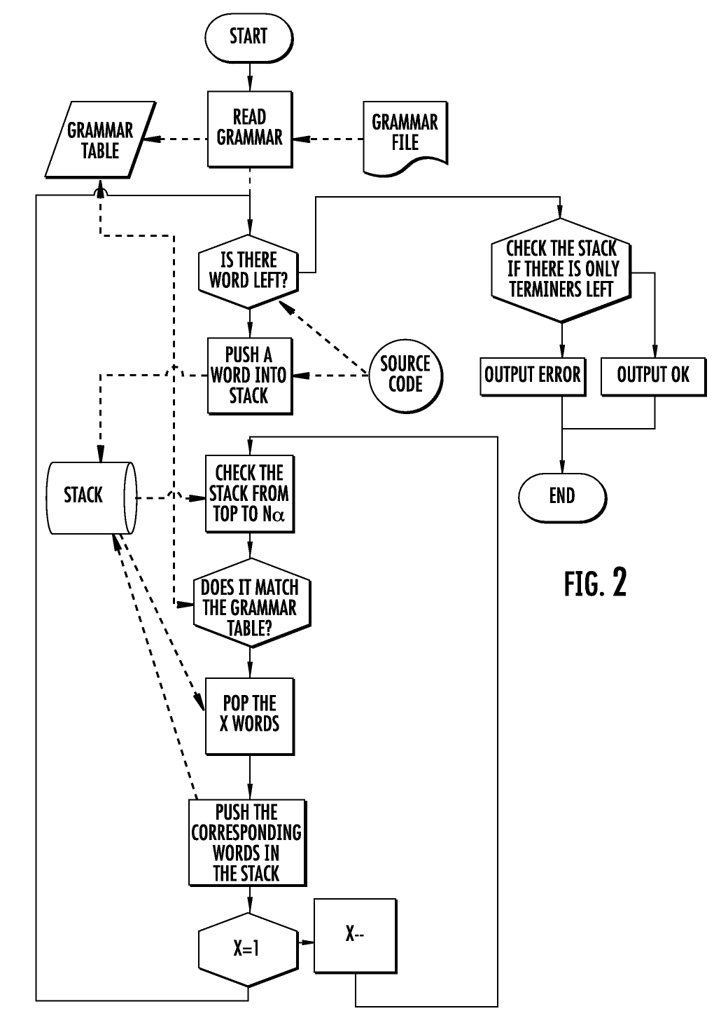

FIG. 3 depicts a home page for a web-based system for nucleic acid construction and validation according to an embodiment of the invention.

FIG. 4 depicts a web page for selection of sequence elements for construction of a construct according to an embodiment of the invention.

FIG. 5 depicts a web page for downloading or otherwise exporting a completed nucleic acid construct according to an embodiment of the invention.

FIG. 6 depicts a web page for validating a sequence according to an embodiment of the invention.

FIG. 7 depicts a web page indicating the results of a valid sequence construction according to an embodiment of the invention.

FIG. 8 depicts a web page containing a selection menu for parts layout from a database of parts (elements) according to an embodiment of the invention.

FIG. 9 depicts a web page allowing users to define new functional elements and assign them to categories according to an embodiment of the invention.

FIG. 10 depicts a web page showing a personalized, user-specific catalog of elements according to an embodiment of the invention.

FIG. 11 depicts a web page of an editor function allowing users to create a user-specific catalog of elements according to an embodiment of the invention.

FIG. 12 depicts a web page listing user-specified libraries according to an embodiment of the invention.

FIG. 13 depicts a web page listing previously designed nucleic acid constructs for a particular user according to an embodiment of the invention.

### DETAILED DESCRIPTION OF VARIOUS EMBODIMENTS OF THE INVENTION

Reference will now be made in detail to various exemplary embodiments of the invention, examples of which are illustrated in the accompanying drawings. The following detailed description is not to be considered as limiting the scope or subject matter of the invention.

Gene synthesis technology now enables molecular biologists to assemble long DNA molecules that can include multiple genes and their regulatory sequences. In this document, these molecules are referred to as “genetic constructs” or just “constructs”. As the throughput of the construct manufacturing increases, the design of complex genetic constructs becomes the bottleneck of the process. It becomes easier to assemble complex DNA molecules than to design them. A natural way of designing complex constructs consists in combining basic building blocks also known as “biological parts” or “genetic parts”. These parts are small DNA fragments implementing specific biological functions. The mechanisms of gene expression require that certain structural constraints are met in order for a construct to be functional. Parts of different types need to be placed in a particular order and next to each other in order to ensure that coding sequences are properly transcribed and translated. Certain parts are functional in a specific context whereas other parts have proved functional in different organisms than the one from which they originate. For instance, promoters are often functional in specific organisms or even cell types, whereas genes coding for proteins can often be expressed in multiple species. The design of complex genetic constructs such as artificial gene networks therefore requires an intimate knowledge of gene expression mechanisms. Experience proves that most biologists who could use sophisticated genetic constructs to control the expression of their gene of interest do not have the expertise to design the construct they need. One way to lower the barrier to entry into synthetic biology is to formalize the structural constraints associated with the use of standardized biological parts in a construct. Such formalism can be used to build software wizards to guide users in the design of their constructs. It can also provide a foundation to the development of parsers capable of verifying the structural validity of a synthetic DNA sequence.

Several prominent synthetic biologists have advocated an engineering approach to the design of genetic constructs. These principles are best illustrated by the Registry of Standard Biological Parts, a service provided by MIT to promote the development and dissemination of well-specified, standardized, and interchangeable biological parts. The records in this database are organized in different categories corresponding to different levels of abstractions. At the bottom of this hierarchy lay the basic parts. Parts can be combined in functional modules called devices. Devices and parts can ultimately be combined in self-contained systems. The “Parts” category is itself subdivided into subcategories (Regulatory, Terminators, RNA, DNA, Protein Coding, Ribosome Binding Sites, and Conjugation) corresponding to biological functions. The database enables users to create new records by combining records corresponding to basic parts, devices, or construction intermediates. Standardized graphical representation of complex records makes it easy to visualize their structure. After examining a number of records, it is possible to identify common features shared by many entries. However, the record editing process is free; no structural rule is imposed on new records nor are the records automatically verified upon submission.

The development of the software product “Gene Designer”, which is a software application to quickly design synthetic DNA molecules from a library of basic parts, has been inspired by a similar vision. The user interface includes a standard library of parts called the Design Toolbox. Its hierarchical organization is multilayered to accommodate sequences specific of multiple biological species and a broader spectrum of biological functions than in the MIT Registry. Gene Designer makes it very easy to drag elements of the toolbox into new DNA sequences. The structure of complex sequences combining multiple parts is visualized by an icon view. However, Gene Designer does not have any wizard guiding the user in the design of a construct nor does it have any feature to verify the structural validity of constructs.

We have developed syntactic models of artificial genetic constructs derived from the combination of standard genetic parts. Parts are organized in syntactic categories and the structural constraints affecting the position of parts in constructs are expressed by production rules. This approach provides a rigorous foundation to the organization of libraries of parts and constructs along with a systematic framework to the design of genetic constructs. Furthermore, these models can be used to build parsers capable of accepting a construct as consistent with a set of production rules expressing currently accepted design principles.

Most of the early applications of linguistic models to the analysis of biological sequences were aimed at analyzing naturally occurring sequences. Grammars were developed with the goal of finding genes and their associated regulatory elements in genomic sequences. Another body of work aimed at predicting the secondary structures of RNA molecules. The discovery of grammatical models from sets of curated biological sequences remains a very active field of research in the machine learning community. Linguistic models have also been used to analyze proteins with different purposes. Most of the work in this field aims at understanding the rules of protein organization in modular domains, but recently grammatical models have been developed with the goal of designing new antimicrobial peptides. This work proceeded in two steps. In order to decipher the design principles of natural antimicrobial peptides, a set of grammars was inferred from natural sequences using a pattern discovery algorithm. In a second step, 42 peptides consistent with the discovered grammars but not homologous to natural peptides were synthesized and tested. Approximately half of the new peptides exhibited an antimicrobial activity, which demonstrates the power of this approach. In the context of this invention, we also formalize grammars to support the design of new DNA sequences, which is a very different goal from the analysis of natural genomic sequences. Instead of inferring the production rules from a training data set, they capture a preexisting biological knowledge relative to structural rules that elements in a genetic construct need to follow.

In the present invention, grammars are also formalized to support the design of new DNA sequences, not the analysis of natural genomic sequences. Productions are used to formally express a preexisting knowledge of structural rules that elements in a genetic construct need to follow. The productions therefore do not need to be inferred from a training data set.

A software according to the invention was developed and implemented as follows:

Variables: The first step in the construction of the grammar was to recognize syntactic categories in categories used to organize genetic parts. These syntactic categories are represented by the variables listed in Table 1. Variables are represented by capital letters and are organized in four hierarchical categories. The first category is limited to S, the start variable from which all derivations are initiated. S also represents transcription units. The second category corresponds to complex fragments of DNA composed of multiple functional parts. This category includes the variables M and N, which correspond to transcription units in the forward and reverse orientation, respectively. A transcription unit is a DNA fragment between a promoter and a transcription terminator. Also in this category is the variable E, which is used to represent coding sequences or DNA fragment composed of a “start” codon followed by one or more protein domains and terminated by a “stop” codon. The third category of variables includes parts that can be duplicated in a construct. For instance, it is common practice to put two transcription terminators G at the end of a transcription unit to ensure a tight termination of the transcript. In category IV are found all the variables that represent basic genetic parts that cannot be decomposed into smaller functional blocks and are not used in series in genetic constructs, such as A (promoter), C (Ribosome binding site), or P (T7 promoter). Variables representing less frequently used parts, such as I and J (riboregulators), are also included in this category.

TABLE 1

| Name | Description | Cat. |
|---|---|---|
| S | Start/Transcription unit | I |
| E | Gene | |
| F | Gene reverse | |
| M | Translation unit | |
| N | Translation unit reverse | |
| G | Terminator | III |
| H | Terminator reverse | |
| O | Linker | |
| R | T7 terminator | |
| T | T7 terminator reverse | |
| U | Protein domain | |
| V | Protein domain reverse | |
| Y | Stop codon | |
| Z | Stop codon reverse | |
| A | Promoter | IV |
| B | Promoter reverse | |
| C | Ribosome binding site | |
| D | Ribosome binding site reverse | |
| I | Riboregulator | |
| J | Riboregulator reverse | |
| K | Hammerhead ribozyme | |
| L | Hammerhead ribozyme reverse | |
| P | T7 promoter | |
| Q | T7 promoter reverse | |
| W | Start codon | |
| X | Start codon reverse | |

The orientation of constructs can be left to right or right to left. If left to right is the direct orientation and right to left the reverse orientation, it is necessary to introduce new variables corresponding to the counterparts in the reverse orientation of most previously defined variables. Stated another way, if left to right is the direct orientation and right to left the reverse orientation, each category of genetic parts needs to be broken down into two syntactic categories corresponding to the direct and reverse orientation as different structural rules apply to each orientation.

Terminal Set: The terminal set is composed of the genetic parts themselves. A comprehensive list of parts organized according to the syntactic categories used in this invention can be provided in a comma-delimited file, an XML file, retrieved from a database, or in any other suitable means that can be imported into a commercial nucleic acid analysis program. Because our parts list has been compiled from multiple sources and the syntactic categories do not always match the categories used in the references describing the parts, parts have been indexed in each syntactic category; promoters a1 to a7, genes e1 to e12, etc. However, the part label in the XML files combines this identifier with the identifier used in the reference where the part information was found. For instance, the part labeled c1_B0034 will be referred as c1 below but its sequence is the same as the sequence of BioBrick BBa_B0034. The XML file provides parts both in the forward and reverse orientation. Parts in the reverse orientation were derived from parts in the forward orientation by a reverse/complement operation. A library of more than 100 parts has been organized according to the syntactic categories used in this disclosure. Parts have been indexed by a unique identifier composed of a prefix corresponding to the part syntactic category and a numerical suffix indexing the parts within each category. For instance, the terminals a01 to a09 point to the promoters of the library, whereas genes are represented by the terminals e01 to e14, etc. In addition to the unique identifier used as terminal in the grammar, the library files include a part name pointing to other sources of information about this part. For instance, the BBa number is reported for parts derived from the MIT Registry of Standard Biological Parts. In addition, the DNA sequence of each part is included in the library as a proof of concept.

Productions and Construct Design: Table 2 includes a list of production rules grouped according to the successive steps followed when designing a genetic construct. The construct design process is somewhat similar to the process of writing a computer program. It starts at S, the transcription unit. P01 can be applied to S several times to fix the construct total number of transcription units. Step 2 of the design process will specify each transcription units by choosing a type of promoter and an orientation. Applying P02 to S will ensure that the transcription unit uses the endogenous RNA polymerase by selecting promoters and transcription terminators compatible with this enzyme. Alternatively, the transcription unit could rely on the bacteriophage T7 RNA polymerase, in which case P04 will be applied to S. Using P02 or P03 will result in transcription units in the direct orientation. Alternatively, P03 or P05 can be used to generate transcription units in the reverse orientation. In Step 3, it is possible to specify if the transcription unit is composed of multiple translation units. Applying P06 or P07 will result in polycistronic transcription units in the direct or reverse orientation respectively. In Step 4, the architecture of transcripts is specified. P08 specifies that M is regular mRNA by decomposing it into a Ribosome Binding Site (RBS) C and a coding sequence E whereas P09 can be used when M is composed of a ribogulator 1 placed between two ribozymes K. The coding sequence E can itself be broken down by P12 into a start codon W, a protein domain U, and a stop codon Y.

Productions P10, P11, and P13 are the counterparts of P08, P09, and P12 for sequences in the reverse orientation. It is not unusual to place more than one part of a particular type in specific location. Step 5 can be used to specify the number of repetitions for each part of the construct that can be repeated. For instance, multiple linkers corresponding to different restriction sites can be placed between transcription units by applying P16 several times. Similarly, it is common to place two successive transcription terminator sequences (P14, P15) or two stop codons (P17, P18) to ensure a tight termination of transcription and translation respectively. P19 and P20 can be used to place additional protein domains to the coding sequence of a gene. In Step 6, it is possible to add linkers, DNA elements having a structural role but not involved in the gene expression mechanisms, on each side of all the parts in the constructs. Typical linkers include restriction sites that could be used to extract parts in a construct and replace it by ligation of a DNA fragment extracted from a different constructs.

TABLE 2

| | | | |
|---|---|---|---|
| P01 | S → SS | Start symbol (S), linker (O), start symbol (S) | Step |
| | | | 1 |
| P02 | S → AMG | Promoter (A), translation unit (M), terminator (G) | Step |
| P03 | S → HNB | Terminator rev (H), translation unit rev (N), promoter | 2 |
| | | rev (B) | |
| P04 | S → PMR | T7 promoter (P), translation unit (M), T7 terminator (R) | |
| P05 | S → TNQ | T7 terminator rev (T), translation unit rev (N), T7 | |
| | | promoter rev (Q) | |
| P06 | M → MM | Translation unit (M), translation unit (M) | Step |
| P07 | N → NN | Translation unit rev (N), translation unit rev (N) | 3 |
| P08 | M → CE | Ribosome binding site (C), gene (E) | Step |
| P09 | M → KIK | Hammerhead (K), riboregulator (I), hammerhead (K) | 4 |
| P10 | N → FD | Gene rev (F), ribosome binding site rev (D) | |
| P11 | N → LJL | Hammerhead rev (L), riboregulator rev (J) | |
| | | hammerhead rev (L) | |
| P12 | E → WUY | Start codon (W), protein domain (U), stop codon (Y) | |
| P13 | F → ZVX | Stop codon rev (Z), protein domain rev (V), start | |
| | | codon rev (X) | |
| P14 | G → GG | Terminator (G), terminator (G) | Step |
| P15 | H → HH | Terminator rev (H), terminator rev (H), | 5 |
| P16 | O → OO | Linker (O), linker (O), | |
| P17 | Y → YY | Stop codon (Y), stop codon (Y) | |
| P18 | Z → ZZ | Stop codon rev (Z), stop codon rev (Z) | |
| P19 | U → UU | Protein domain (U), protein domain (U) | |
| P20 | V → VV | Protein domain rev (V), protein domain rev (V) | |
| P21, P22, P23 | A → OA \| OAO \| AO | Linkers can be added on each side of the parts | Step |
| P24, P25, P26 | B → OB \| OBO \| BO | | 6 |
| . . . | . . . | | |
| P93, P94, P95 | Z → OZ \| OZO \| ZO | | |
| P0100, P0101 . . . | S → s1 \| s2 \| . . . | All variables can be transformed into terminals. | Step |
| P0200, P0201 . . . | E → e1 \| e2 \| . . . | | 7 |
| P300, P301 . . . | F → f1 \| f2 \| . . . | | |
| . . . | . . . | | |
| P2400, P2401 . . . | Z → z1 \| z2 \| . . . | | |

At this stage of the design process the general architecture of the construct is completely specified as a series of parts belonging to specific functional categories. However, the specific parts used to build the construct are yet to be specified. For instance, the construct could be described by a string such as ACWUUUYY (promoter, RBS, start codon, 3 protein domains, stop codon) but the particular promoter, RBS, start and stop codons, or the protein domains used to assemble a specific construct have not yet been specified. Therefore, this string does not describe a specific construct but a family of constructs expressing a protein. This family includes a wide range of transcription and transcription levels and any protein composed of three domains.

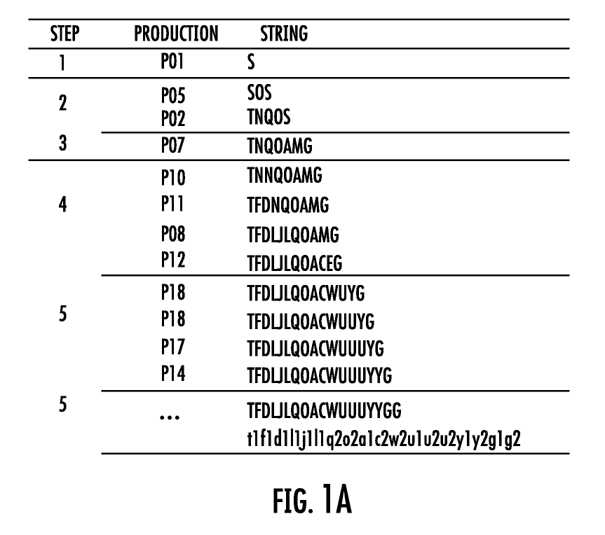

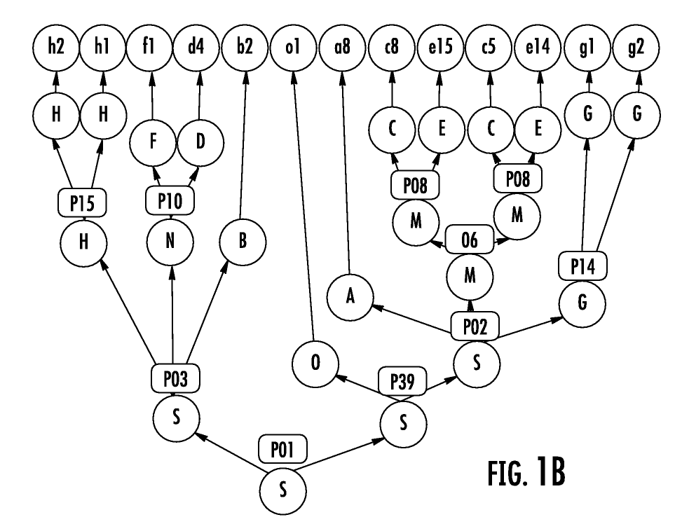

The last phase of the design process (Step 7) comprises transforming variables into terminal symbols pointing toward specific DNA sequences. Productions corresponding to this step are the most numerous because there is one production for every part available to the designer. Table 2 provides only the general architecture of this last group of productions. Productions starting from the same variable have been grouped on a single line using the standard notation: “Variable->Terminal 1 |Terminal 2| . . . ” indicating that a variable can be transformed into any of the terminals separated by |. All the grammar variables can potentially be transformed into a terminal or this type of transformation can be restricted to a category of variables corresponding to the most basic genetic parts. For instance, a variable like E (gene) can be transformed into terminals corresponding to self-contained coding sequence or it can be transformed into a coding sequence composed of multiple domains between a start and stop codon. The most of extreme case would be to include productions allowing the transformation of the start symbol S into a terminal. Allowing this type of production in the grammar maximizes flexibility since any DNA fragment can be made valid. However, this option makes it possible to completely bypass the design process enforced by the grammar. The design process is illustrated in FIG. 1. The design process is completed when all non-terminal variables have been transformed into terminals. At this stage the construct is represented by a series of terminal part identifiers. This high-level description of the construct can be converted into a DNA sequence suitable for gene synthesis using the sequence data of each of the parts in the part library. A software application implementing the construct design process is available.

Parsing and Construct Verification: The construct design process applies a series of productions starting from S to generate a construct with a structure consistent with the grammar rules. The design process therefore “derives” the construct from S. A computationally more demanding question is to evaluate if a specific construct can be generated by a given grammar. In order to answer this question, it is necessary to find one derivation or successive application of productions that will transform S into the construct. This operation is called parsing. By parsing a construct, it is possible to verify its design, which is most useful if the construct was not generated by the systematic process outlined in the previous section. Prior to parsing the construct, it is preferred to perform a lexical analysis of the construct DNA sequence to transform it into a series of parts. As a proof of concept, we have developed a basic lexical analyzer that scans the parts list and compares the sequence of each part with the start (leftmost) sequence of the construct sequence. If the part does not match the start of the construct sequence, the next part in the library is evaluated. At the end of the scan, it is possible that no part matches the beginning of the construct sequence, in which case, the construct is rejected. If only one match is found, then the part matching the construct sequence is recorded and the rest of the construct DNA sequence is analyzed in the same way as the beginning of the sequence was in the first iteration. It is also possible that several matches are found if the parts library includes complex parts composed of more basic parts. In this case all the matches are recorded possibly leading to multiple lexical interpretations of the construct sequence. The presence of multiple interpretations of a construct DNA sequence is an indication that the parts list is redundant in the sense that it includes complex parts that can be obtained by concatenation of more basic parts. It would be preferable to ensure that the grammar defined on the parts library includes rules allowing the derivation of complex parts from the basic parts.

The development of efficient parsing algorithms is an important problem in computer science because its solutions directly affect the performance of interpreters and compilers of programming languages. An introduction to parsing methods can be found in computer science textbooks. JFLAP provides two types of parsers for the type of grammars described in the previous section. The brute force parser performs an exhaustive search in the derivation space. It is very ineffective and even relatively simple constructs such as the one derived in FIG. 1A cannot be parsed in a practical computation time. Another parsing method, named SLR, is also available. S stands for simple LR. L means that the input string (the construct) is processed from left to right. R means that the derivation will be rightmost, i.e., the rightmost variable is replaced at each step. Lastly, 1 means that only one symbol is in the input string is used to guide the parse. The parser output is a derivation that can be visualized in different ways including the derivation tree FIG. 1B.

Software Implementation: There are multiple software and parsing algorithms available in the art (e.g., Prolog) that can be used to define a grammar and verify that an input string is consistent with a specific grammar. For example, JFLAP is a very nice tool to experiment with formal languages but it is not suitable for the development of complex grammars or the analysis of large strings. YACC and Bison are production grade development tools, but they require proficiency in the C programming language. In order to make it possible for people with no programming skills to develop new grammatical models of genetic constructs, we have developed an exemplary software application that can either be used to guide users in the design of new genetic constructs, or to verify previously defined genetic constructs.

The first function that the software provides is to verify the input constructs and see whether they are consistent with the given grammar. One of the advantages with the software is that users can customize the grammar and update the parts library by easily editing the CSV files. The comma-separated values (or CSV; also known as a comma-separated list) file format is a file type that stores tabular data. The format is very old, dating back to the days of mainframe computing. For this reason, CSV files are common on all computer platforms. Contrarily, in the software developed using Bison, to achieve this goal we need to modify the source code and compile it again, which needs more programming experience and is less user friendly. It is notable that there are some recursive rules in our grammar, like: G->GG (which means a tight termination) and this ambiguous setting will result in shift/reduce conflicts in the compile process. Bison resolves this kind of conflict by always choosing to shift rather than to reduce. However we decided not to use this strategy but to assign different precedence to the rules in the grammar to avoid this problem. The software of the invention is constructed based on the notion of the LR(0) parsing algorithm. LR(0) parsers read their input from left to right and produce a rightmost derivation without looking ahead any unconsumed input symbols. The algorithm can given as follows:

1) Push the leftmost token into stack.

2) Lookup the grammar table to see whether the entire stack can be reduced according to the rules. If yes, reduce it and repeat 2. Otherwise proceed to step 3.

3) Compare the substring which consists the topmost n-i tokens in the stack with the grammar rules to reduce it. Here, n is the depth of the stack while 0≦i≦n.

4) When there is no substring that can be reduced in the stack, push a new leftmost token until there is no more token from the input. Repeat step 2.

5) If there is only S (the start symbol) in the stack and no token left in the input, report that the parsing was successful.

On top of the parser function of the software, we took a step further to develop a wizard that can guide the users to build up the correct constructs by simply selecting options provided in the software. The algorithm used to develop this wizard function in the software is:

1) Read the grammar table from CSV file.

2) Initialize a string code with start symbol S.

3) Read the first nonterminal from Code string (if encounter a terminal, skip it and read the next).

4) Lookup this nonterminal in the grammar table, if found read the corresponding derivates in the vector. Otherwise report error.

5) Display all these derivates for user to choose, while the option 0 means to choose its terminal form.

If option 0 is chosen, replace the nonterminal with its terminal form.

Otherwise replace the nonterminal with the selected derivative form.

Repeat step 3, until there are only terminals in Code string.

Experimental Validation: In order to validate both the grammar in Table 2 and the software application, a series of complex constructs listed in the Registry and in publications is reported in Table 3. Each complex construct is identified by the identifier used in the source reference. Constructs are described by a series of lexical tokens corresponding to basic genetic parts. Most constructs were selected to illustrate different types of construct architectures generated by the grammar. However, some constructs outside of the language generated by the grammar have also been introduced in this validation set as controls. The third column of Table 3 indicates the expected outcome of the construct parsing followed by the parsing results produced by the Bison-generated compiler and by software of the present invention. Some comments are provided to explain why some constructs failed the verification. Bison and the software of the present invention returned parsing results consistent with the expectation for all the 40 constructs of this test suite.

TABLE 3

| ID | Source | Symbolic representation | Parsing | Comment |
|---|---|---|---|---|
| BBa_J04450 | Registry | a03c01e01g03 | Pass | |
| BBa_E7104 | Registry | a07c03e09g04 | Pass | |
| BBa_I13520 | Registry | a01c01e01g01g02 | Pass | |
| BBa_J45100 | Registry | a02c02e02g01g02 | Pass | |
| BBa_I13521 | Registry | a02c01e01g01g02 | Pass | |
| BBa_J45120 | Registry | a02c03e02g01g02 | Pass | |
| BBa_J04430 | Registry | a03c01e09g01g02 | Pass | |
| pMKN7a | Toggle | a08c08e14g01g02 | Pass | |
| pBAG102 | Toggle | a10c06e14g01g02 | Pass | |
| pBAG103 | Toggle | a10c04e14g01g02 | Pass | |
| pBRT21.1 | Toggle | a09c07e14g01g02 | Pass | |
| pBRT123 | Toggle | a09c10e14g01g02 | Pass | |
| pBRT124 | Toggle | a09c09e14g01g02 | Pass | |
| pBRT125 | Toggle | a09c11e14g01g02 | Pass | |
| BBa_J13004 | Registry | a02c01e03c01e04g01g02 | Pass | |
| BBa_I13515 | Registry | a01c01e01c01e09g01g02 | Pass | |
| BBa_I13513 | Registry | a01c01e01o02c01e09g01g02 | Pass | |
| BBa_I13604 | Registry | a02c01e04g01g02a06c01e03g01g02 | Pass | |
| BBa_I13605 | Registry | a06c01e04g01g02a02c01e03g01g02 | Pass | |
| BBa_I13607 | Registry | a06c01e10g01g02a02c01e11g01g02 | Pass | |
| BBa_J5517 | Registry | a01c01e12g01g02a06c03e09g01g02 | Pass | |
| BBa_J5518 | Registry | a01c01e12g01g02a06c01e01g01g02 | Pass | |
| pTAK102 | Toggle | h02h01f01d04b02a08c07e14g01g02 | Pass | |
| pTAK103a | Toggle | h02h01f01d07b02a08c10e14g01g02 | Pass | |
| pTAK106 | Toggle | h02h01f02d04b02a08c07e15g01g02 | Pass | |
| pTAK107 | Toggle | h02h01f02d07b02a08c10e15g01g02 | Pass | |
| pIKR108 | Toggle | h02h01f02d01b03a08c04e16g01g02 | Pass | |
| pIKE110 | Toggle | h02h01f02d03b03a08c06e16g01g02 | Pass | |
| pTAK117 | Toggle | h02h01f01d04b02a08c08e15c05e14g01g02 | Pass | |
| pTAK130 | Toggle | h02h01f01d07b02a08c08e15c05e14g01g02 | Pass | |
| pTAK131 | Toggle | h02h01f01d06b02a08c08e15c05e14g01g02 | Pass | |
| pTAK132 | Toggle | h02h01f01d08b02a08c08e15c05e14g01g02 | Pass | |
| pIKE105 | Toggle | h02h01f01d01b03a08c08e16c05e14g01g02 | Pass | |
| pIKF107 | Toggle | h02h01f01d03b03a08c08e16c05e14g01g02 | Pass | |
| BBa_J23022 | Registry | I01g01g02 | Fail | No promoter |
| BBa_J36335 | Registry | a03c01e05a03c01e06 | Fail | Lack of terminator |
| BBa_J44003 | Registry | o01a04o01c02e07 | Fail | Lack of terminator |
| BBa_J45119 | Registry | c03e02g01g02 | Fail | No promoter |
| BBa_J52038 | Registry | a05e08 | Fail | No RBS, no terminator |
| BBa_E0241 | Registry | c03e09g04 | Fail | No promoter |
| BBa_J5516 | Registry | a01c01e12g01g02a06 | Fail | 0rphan promoter in 3′ |

Discussion: Even though a single grammar has been presented in the context of this work, it is important to stress that the grammar of this Example is a somewhat arbitrary set of design of principles. It certainly does not encompass all natural DNA sequences. A number of complex features found in natural sequences, such as overlapping genes, introns, splicing sites, and alternative splicing can be incorporated into other versions of the software. Even designers of some synthetic constructs have used unusual architectures that are not included in the language generated by the grammar of this Example. For instance, multiple promoters have been used to control the expression of a gene. By adding the production A→AA to the grammar in Table 2, it is possible to authorize the use of multiple promoters in constructs. This example shows that the grammar is nothing more than a set of accepted rules selected by the user of the software to design new constructs or analyze preexisting constructs. These rules come from the current understanding of the molecular mechanisms controlled by the different genetic parts used in genetic constructs. Although not depicted in this Example, it should be evident that any desired grammar, rules, etc. can be incorporated into software according to the invention.

Software applications like the present one can use syntactic models of genetic constructs to increase the productivity of individual users. Syntactic models could also be used to improve infrastructures serving the entire community. Syntactic categories provide a rigorous foundation to the organization of genetic parts in different categories. The “Transcriptional regulator” category of the Registry contains a large collection of prokaryotic promoters. However, some complex constructs composed of multiple parts (BBa_I13005 or BBa_J24669) are also found in this category even though they would probably fit in a category corresponding to a higher level of abstraction. Similarly, a number of eukaryotic promoters are listed in the “Transcriptional regulator” category. It might be preferable to have eukaryotic transcription activators listed in their own category as they are not compatible with other prokaryotic genetic parts. Similarly, a number of constructs are currently listed in the Registry that are not self-contained. For instance BBa_J45119 does not include a promoter but uses a transcription terminator from bacteriophage T7. In some instances, it would be preferable to indicate when listing this part that it needs to be inserted in 5′ of a T7 promoter. By developing a syntactic model of community infrastructures, it would be possible to verify user submission and verify existing content. As artificial gene networks become more complex by combining parts coming from distant organisms, a broader syntactic model can be developed that will help articulate rules of compatibility between parts. Of particular importance is to capture existing knowledge of the use of prokaryotic transcription factors in eukaryotes.

As syntactic models of genetic constructs become broader, it might become necessary to specify the context in which the construct will be used. The present invention allows for this adaptation. The tetracycline repressor has been shown to work in multiple organisms, including mammalian cells and some plants. However, it is also believed to be toxic in some plants. In this context, the distinction between prokaryotes and eukaryotes might be not sufficient. The distinction between mammalian cells and plant cells might not be sufficient either, but it might be desirable to specify the species in which this transcription factor can be used. Similarly, a number of eukaryotic promoters are tissue-specific, whereas the activity of other promoters is not affected by the type of cells in which they are used. The T7 promoter can be used in many species and cell types as long this cell expresses the T7 RNA polymerase. The presence or absence of the T7 RNA polymerase gene introduces another context. Each context will require the development of separate sets of production rules but some parts should be useable in multiple contexts. The power of the present invention and its breadth allows for inclusion of such separate production rule sets without altering the general scheme of the invention.

The models and tools presented in this disclosure rely, at least to some extent, on a higher level of abstraction than the DNA sequence. When using a syntactic model to guide the design of a new construct, it is straightforward to translate the description of the construct into a sequence because each genetic part corresponds to a unique sequence.

As mentioned above, the sequence of artificial genetic constructs is composed of multiple functional fragments, or genetic parts, involved in different molecular steps of gene expression mechanisms. Biologists have deciphered structural rules that the design of genetic constructs needs to follow in order to ensure a successful completion of the gene expression process. We show that grammars can formalize these design principles. This approach provides a path to organizing libraries of genetic parts according to their biological functions which correspond to the syntactic categories of the grammar. It also provides a framework to the systematic design of new genetic constructs consistent with the design principles expressed in the grammar. Using parsing algorithms, this syntactic model enables the verification of existing constructs. We illustrate these possibilities by describing a grammar that generates the most common architectures of genetic constructs in E. coli. We have compiled a library containing close to 100 genetic parts according to the syntactic categories of this grammar. The architecture of 40 previously published constructs was represented using the library parts identifiers and verified by LR(0) parsing. A basic lexical analyzer was also developed to demonstrate the possibility of verifying the DNA sequence of genetic construct. We illustrate this possibility both using the theoretical sequence of constructs and the experimentally determined sequence of a library of 35 artificial gene networks.

It is to be noted that the specific grammar presented above in this example has only 26 syntactic categories, each represented by a single capital letter. However, nothing would prevent the development of a more complex grammar requiring additional variables coded on two or more capital letters. Furthermore, the boundaries between the four categories used in Table 1 are arbitrary and have no consequence on the rest of the developments. Listing variables in alphabetical order would have been equally acceptable as would other listing schemes.

In order to further validate the lexical analyzer, we analyzed the published sequences of several bistable genetic switches. When looking at sequences of genetic constructs, legacy DNA sequences are often present between the functional sequences. They result from the molecular cloning processes that led to the assembly of the plasmids. The CFG includes productions allowing the presence of linker sequences to the left of any variable. These productions make it possible to treat legacy DNA as linkers. The published sequences of the bistable switches were carefully analyzed and structural DNA between functional fragments was identified and recorded as linkers in the parts list. The lexical analyzer could then parse the DNA sequences and generate an output that includes more linkers than what appeared from the diagrammatic representations of these plasmids. Yet, parsing the symbolic representation of the constructs generated by the lexical analyzer leads to results consistent with the simpler representation derived from the diagrammatic representation of the plasmids.

The same approach can be used to compare experimental sequence data with the theoretical sequence of the construct. Using the theoretical sequence of a combinatorial library of plasmids, the sequences of the linkers located between the genetic parts of the construct was identified and recorded in the parts library. Sequencing the region comprised between Pi and the 3′ end of the GFP gene in the 35 previously characterized plasmids revealed some discrepancy between the plasmid theoretical sequence and their actual sequence. The parser accepted the sequences consistent with the theoretical sequence and rejected the sequences inconsistent with the theoretical sequences. This example shows that the lexical analyzer/parser is capable of handling large sequences encompassing up to four genes and their regulatory sequences.

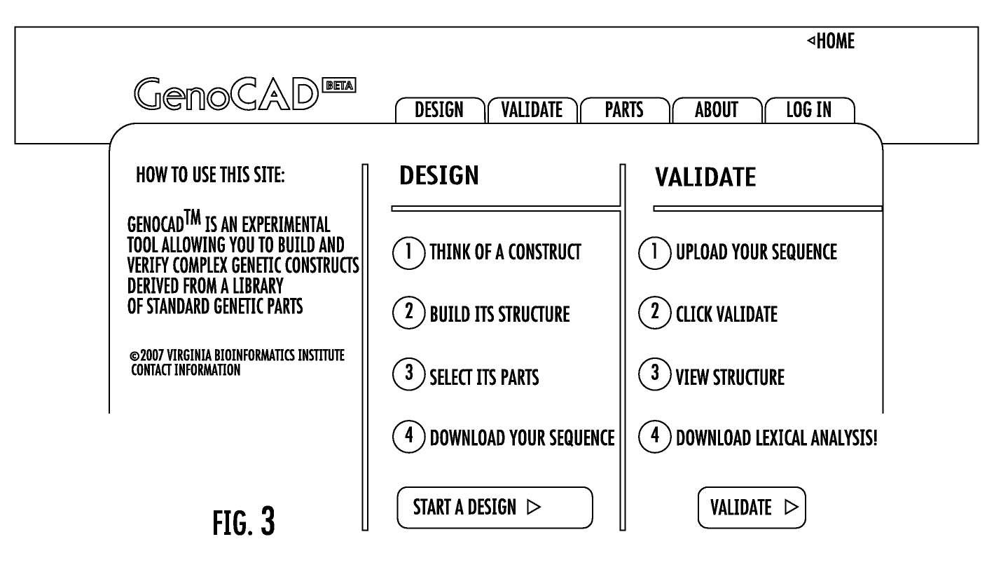

Turning back now to the figures, FIGS. 3 through 13 depict web pages of a web-based nucleic acid creation and validation system according to one embodiment of the invention, which is referred to as GenoCAD. The system employs a computer connected to the Internet, which runs software that enables users to create and validate nucleic acid constructs. It also provides additional features, such as the ability to maintain and manipulate libraries of constructs that are specifically designed and/or validated by a particular user.

FIG. 3 depicts a web page for access to the features of the system. Tabs are available for nucleic acid design and verification (which can be performed separately as independent actions). Typically, the design function of the system is used to create nucleic acid constructs having proper physical placement of elements. That is, when a user uses the design function, the system will permit creation of constructs that are correct/valid for grammar. It thus includes both the design and validation functions. Alternatively, where a user already has a construct, but wants to validate it, the user may select the validate tab to import and validate the construct. The processes for both design and validation are generally indicated on the page.

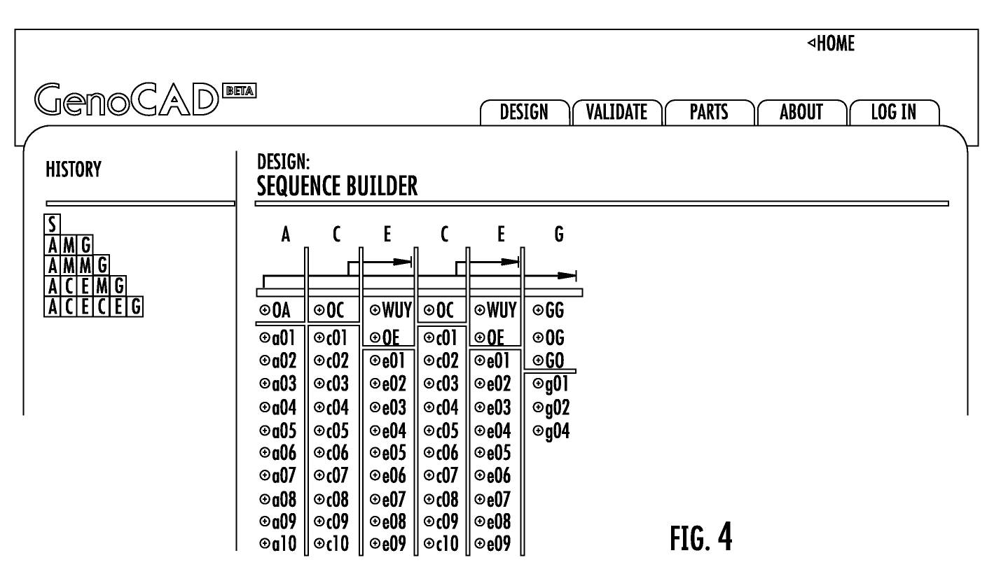

FIG. 4 depicts the first step in the design phase of construct building. It provides a wizard in which syntactic categories have specific icons associated to them. In this page, a user can click on any item under the icons to choose a production rule of the grammar. The items are categorized elements in a database from which the user may select any one element per category.

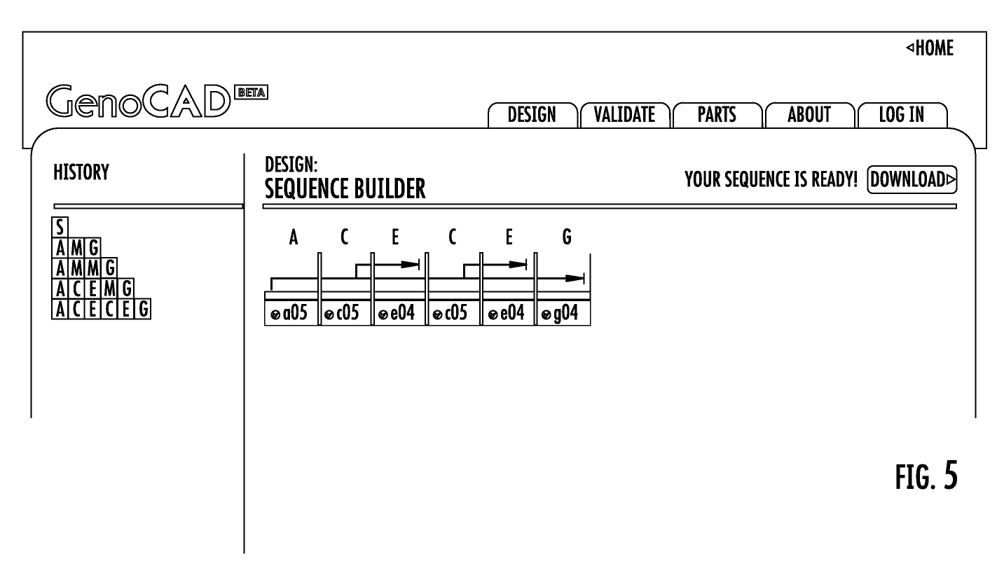

FIG. 5 depicts a completed construct designed according to FIG. 4. In this particular example, a construct having elements ACECEG has been designed, and is ready for downloading in a text file that can be used as input to a fabrication process. In this design system, the construct is already validated and ready for physical fabrication. As can be seen in the Figure (and in FIG. 4), history for design of the construct is shown on the web page, allowing the user to identify the steps followed in designing the construct. At each step, the construct may be modified to replace originally-selected elements to achieve a valid construct.

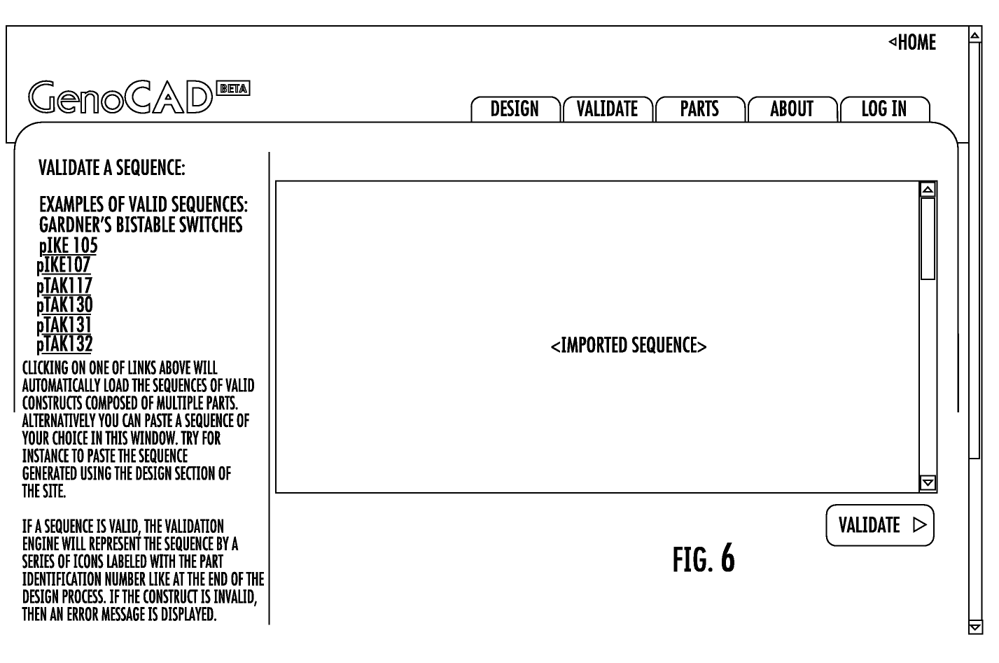

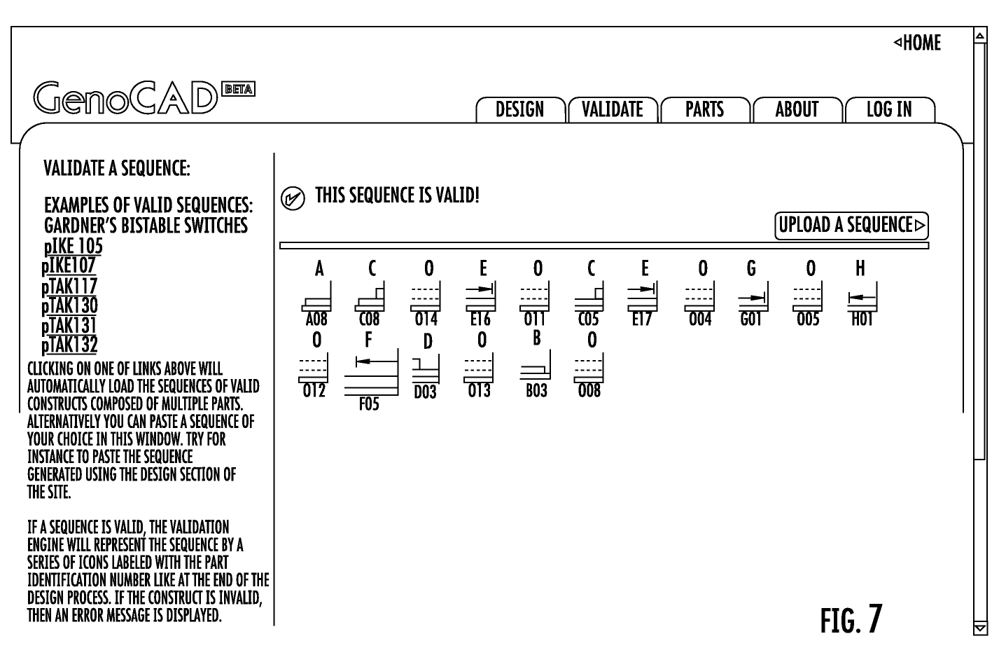

FIG. 6 depicts the first step in the validate function of the system. As mentioned above, the validate function is useful for validating nucleic acid constructs designed by means other than the design function of the present system. In this first step, the user uploads to the system (e.g., by pasting a text file of a nucleic acid sequence into the text box on the web page) a previously-designed construct. The user then clicks on the “validate” button and the system analyzes the construct for proper construction. As indicates on the web page, a valid construction will be represented by a series of icons (similar to that shown in FIG. 7), but an invalid construction will result in an error message being displayed to the user. As shown in FIG. 7, when a valid construct is uploaded, the parser can recognize its structure and the functional elements it is composed of, and can represent those elements as icons.

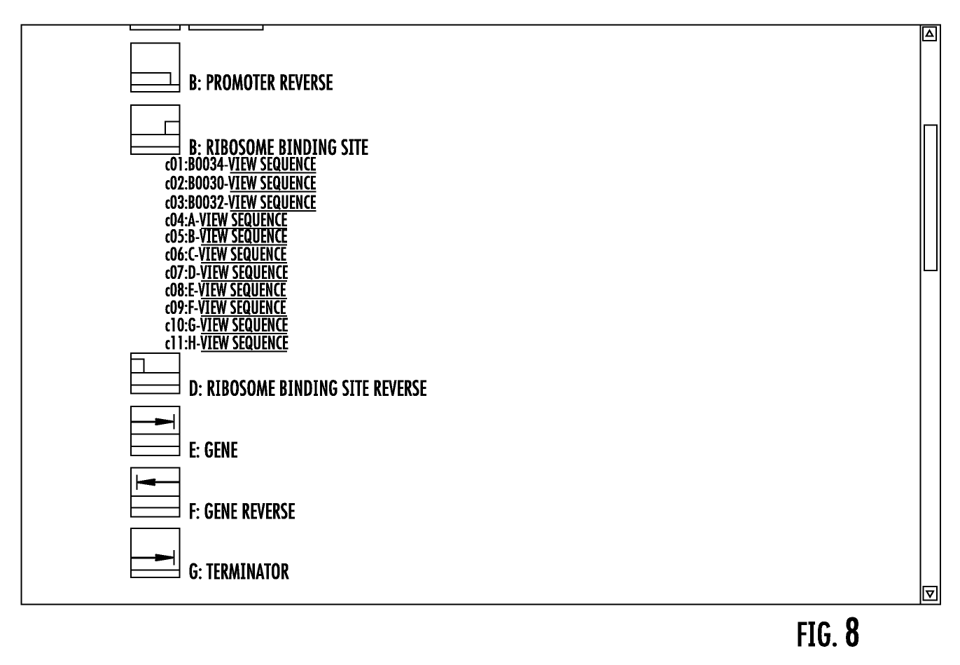

FIG. 8 depicts a partial parts (elements) list of parts maintained in a database of parts available for selection by users. The parts are organized by grammar syntactic categories, and listed in alphabetical order, generally corresponding to the linear placement of elements in a valid construct for expression of a protein. Users may access this list from a tab on the home page depicted in FIG. 1. As can be seen from FIG. 8, each category comprises multiple elements from which can be chosen a correct element for the construct being designed. This feature may be used as part of the design function of the system or may be used as part of the validate function to replace invalid elements in a nucleic acid designed by means other than the present design function. Upon completion of selection of all valid elements, a valid construct can be downloaded for physical fabrication.

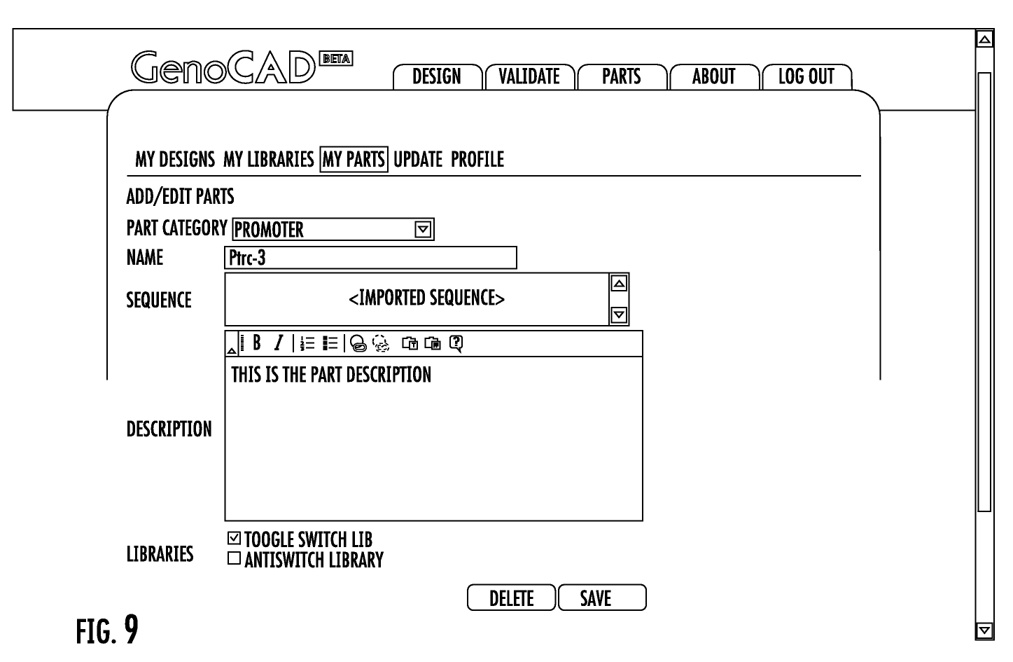

Among the many features of the system, one feature allows users to define new functional elements and assign them to categories. This feature is depicted in FIG. 9, which shows the “Parts” tab of FIG. 3 when using it to add a part for the first time. In use, a user can select an appropriate category from a drop-down list (“Part Category”) and provide a user-defined name (“Name”). The actual sequence may be pasted into the text box (“Sequence”) and a description of the sequence can be entered (“Description”). Finally, the type of library may be chosen by selecting the appropriate check-box. If satisfied, the user may save the entry by clicking the “Save” button. Alternatively, if for some reason the user does not wish to save the entry, it may be deleted by clicking the “delete” button. It is to be noted that numerous parts in numerous categories may be defined, allowing each user to create a personalized library of parts for use in building and validating future constructs.

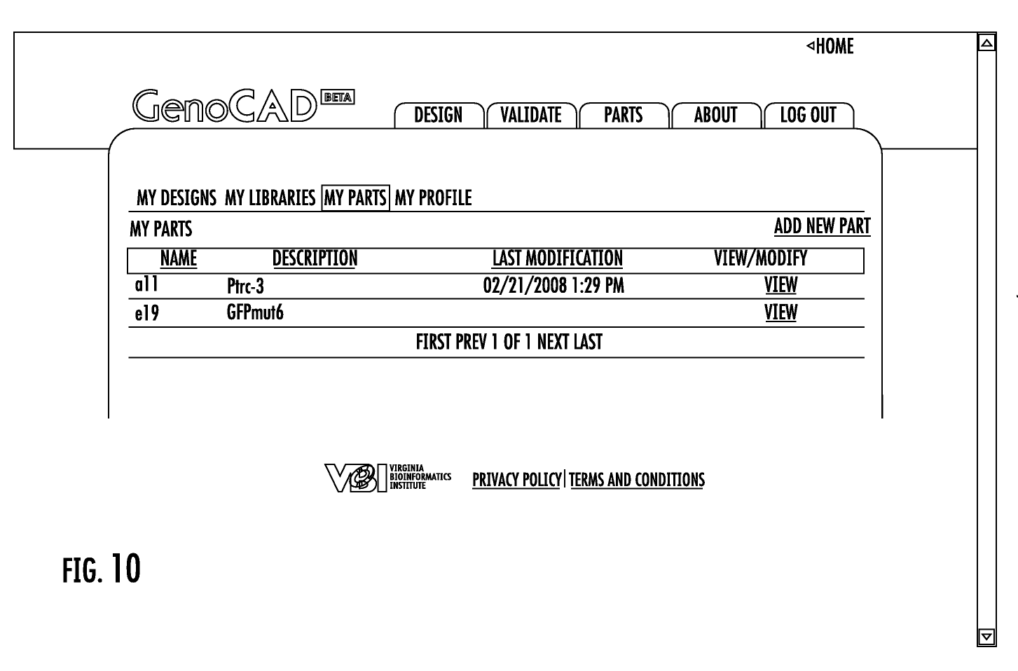

FIG. 10 depicts a list of user-defined parts. This list is populated under the “Parts” tab of the home page. As compared to FIG. 9, FIG. 10 depicts the user-defined parts list after one or more (in this case two) parts are defined. One or more of the parts may be selected for use in building additional constructs by selecting the part of interest.

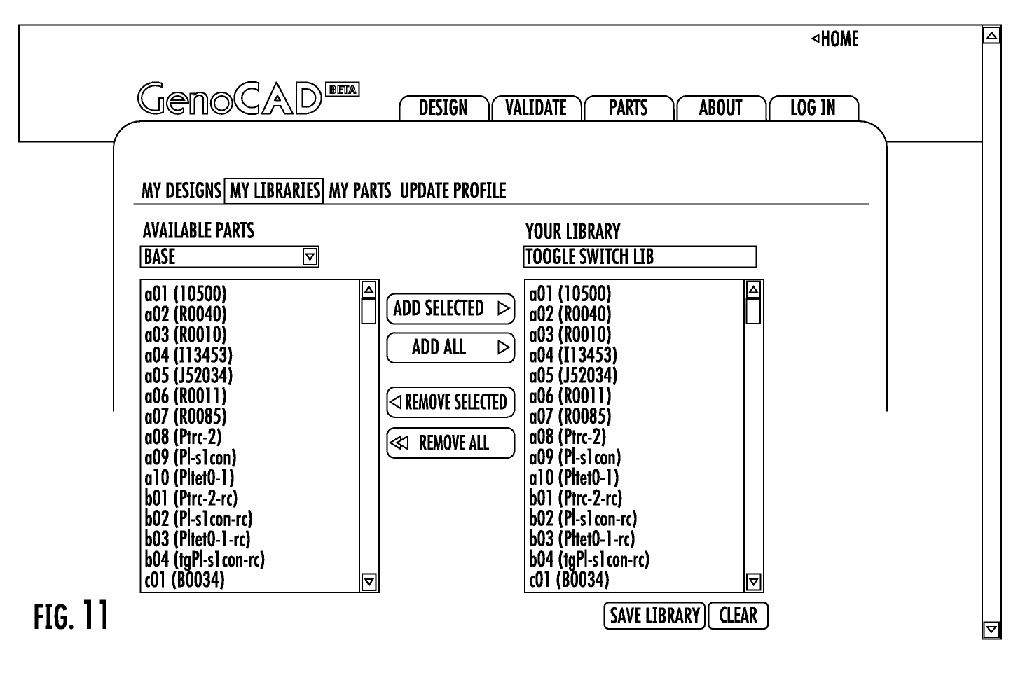

Parts defined by users may be further organized into libraries of parts. As depicted in FIG. 11, a drop-down list of available parts can be used to select an appropriate type of part. The editor function of this feature allows users to define specialized libraries of functional elements, and allows them to develop constructs for specialized functions.

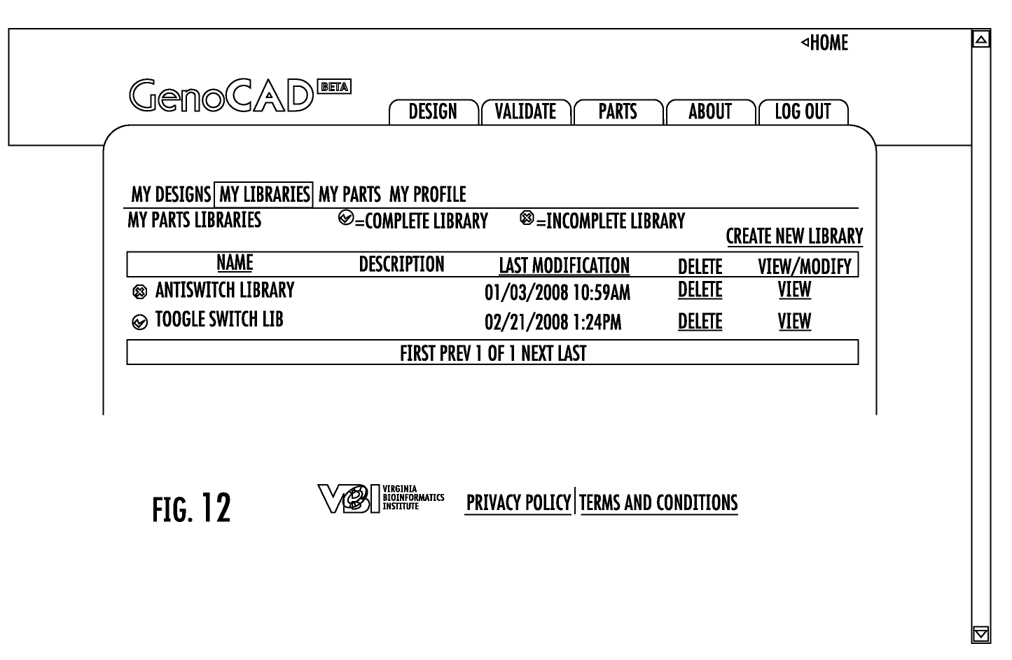

An additional layer of power is provided by the system, as depicted in FIG. 12. In this figure, it is shown that a user may have a set of defined libraries. For example, a user may have a library of parts specific for expression of genes in E. coli and another library of parts specific for expression of genes in human cell culture HELA cells. In the example depicted in FIG. 12, two libraries, “Antiswitch Library” and “Toggle Switch Lib” are available to the user. The completeness of each library for construct design is indicated to the left of each library, with a red button (button labeled with an x mark) or a green button (button labeled with a check mark). As with other features involved with parts creation and maintenance, each library may be viewed, modified, and/or deleted by selecting the appropriate link on the page.

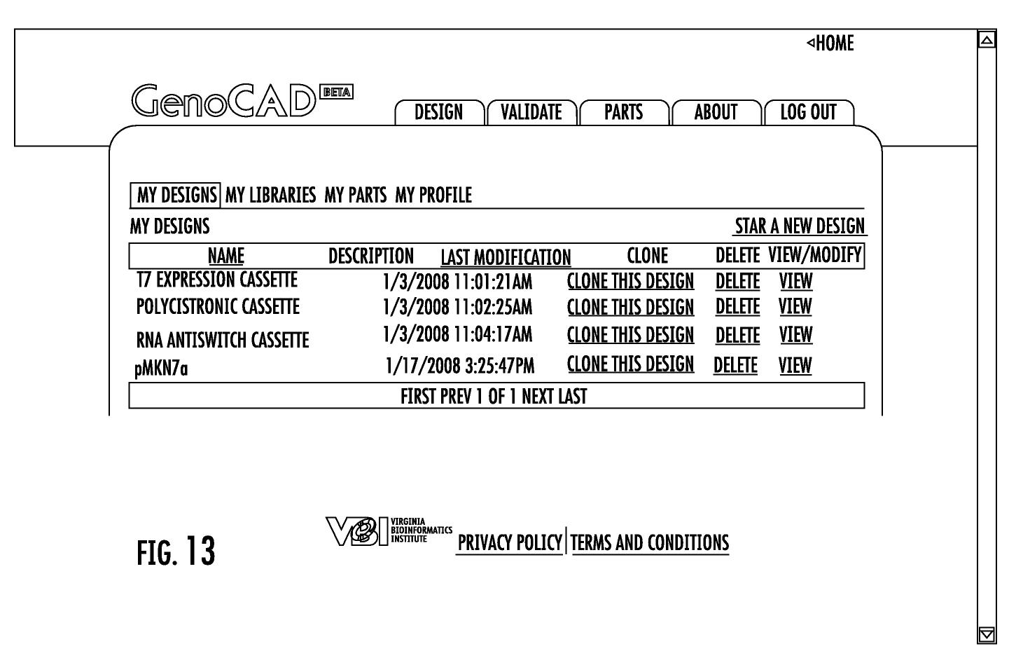

FIG. 13 depicts another feature of the system generally depicted in FIG. 3. In this feature, a user may maintain and modify various designs created at some point in the past. The figure shows a web page of a list of previously designed constructs. Users may maintain their construct designs on this page and use them at a later date, for example where additional or alternative proteins are to be produced in the same system used previously. As an example, the figure shows that a user may maintain a T7 Expression Cassette construct, which was used successfully to produce a protein. The design elements of the cassette can be used to create additional expression cassettes, for example by replacing the coding region of the cassette with a coding region for another protein. This feature is particularly beneficial to users who routinely use a particular expression system and wish to standardize expression of proteins based on a single cassette.

It will be apparent to those skilled in the art that various modifications and variations can be made in the practice of the present invention without departing from the scope or spirit of the invention. Other embodiments of the invention will be apparent to those skilled in the art from consideration of the specification and practice of the invention. It is intended that the specification and examples be considered as exemplary only, with a true scope and spirit of the invention being indicated by the following claims.

1. An automated method for verifying that a nucleic acid construct has a correct combination and placement of functional elements to achieve an intended purpose, said method comprising:
obtaining a nucleic acid sequence of interest;
analyzing the sequence for elements present in the sequence; and
determining if two or more of the elements are in the correct physical relationship to each other to provide the intended purpose of the construct.

2. The method of claim 1, wherein the steps of analyzing and determining are performed by a computer and do not involve human intervention.

3. The method of claim 1, further comprising providing information to a user of the method regarding whether the physical relationships of the elements are correct for the intended purpose.

4. The method of claim 5, wherein the information is a warning that two or more of the elements are not in the correct physical relationship.

5. The method of claim 1, wherein the intended purpose is expression of one or more proteins or RNA molecules from the construct.

6. The method of claim 1, wherein the intended purpose is to express a chimeric or fusion protein.

7. Software comprising instructions for executing the method of claim 1.

8. An automated method for design of a nucleic acid construct having a correct combination and placement of functional elements to achieve an intended purpose, said method comprising:
providing a user the ability to select at least two elements defined by nucleotide sequences; and
providing the user the ability to place each element at a correct position relative to the other element(s) to create a nucleic acid construct that achieves the user's intended purpose;
wherein the automated method allows selection of only those elements that, when in combination with all other elements present on the construct, are suitable for achieving the user's intended purpose, and
wherein the automated method allows placement of each element only at a correct physical location with respect to all other elements in order to achieve the user's intended purpose.

9. The method of claim 8, wherein the steps of analyzing and determining are performed by a computer and do not involve human intervention.

10. The method of claim 8, wherein the automated method does not provide the user the ability to select an element that is not valid in the context of the other elements, and does not provide the user the ability to place an element in an incorrect position relative to the other element(s).

11. The method of claim 8, wherein the intended purpose is expression of one or more proteins or RNA molecules from the construct.

12. Software comprising instructions for executing the method of claim 8.

13. A system for nucleic acid construct design, said system comprising:
at least one computing device that is capable of executing the software of claim 12, and the software of claim 12.

14. The system of claim 13, comprising at least one computing device that is connected to the Internet.

15. The system of claim 14, further comprising at least one database of nucleic acid elements.

16. A system for nucleic acid construct verification, said system comprising:
at least one computing device that is capable of executing the software of claim 7, and the software of claim 7.

17. The system of claim 16, comprising at least one computing device that is connected to the Internet.

18. The system of claim 16, further comprising at least one database of nucleic acid elements.

19. An automated method for design of a nucleic acid construct having a correct combination and placement of functional elements to achieve a desired function, said method comprising:
providing a user the ability to request a nucleic acid construct having a desired function;
automatically selecting appropriate functional elements and appropriate spacings of elements to achieve the user's desired function; and
combining the selected functional elements in appropriate physical relationships to each other.

20. The method of claim 19, wherein the method does not require the user to specify any particular functional elements.

21. The method of claim 19, wherein the method permits the user to obtain a valid nucleic acid construct sequence without having any knowledge of the identity or nucleic acid sequence of any element present in the nucleic acid construct.

22. The method of claim 19, wherein the desired function is a construct that includes no elements covered by intellectual property rights, a construct that is suitable for expression of one or more proteins or RNA molecules in a pre-defined expression system, or a construct that is suitable for expression of one or more fusion or chimeric proteins.

23. A method of doing business with a computer, said method comprising:
providing the software of claim 7 on a first computer connected to the Internet;
providing one or more other computers access to the first computer through the Internet; and
charging a fee to use the software.

24. A method of doing business with a computer, said method comprising:
providing the software of claim 12 on a first computer connected to the Internet;
providing one or more other computers access to the first computer through the Internet; and
charging a fee to use the software.
